(19) United States
(12) Patent Application Publication
(10) Pub. No.: US 2002/0079878 A1
(43) Pub. Date: Jun. 27, 2002

(54) Device for controlling in rush current to power factor correcting capacitor bank

(76) Inventor: David L. Swindler, Murfreesboro, TN (US)

Correspondence Address: SQUARE D COMPANY, 1415 South Roselle Road, Palatine, IL, 60067, US

(21) Appl. No.: 09/748,688

(22) Filed: Dec. 22, 2000

(51) Int. Cl. H02M 7/00

(52) U.S. Cl. 323/908

(57) ABSTRACT

A power factor correction circuit for controlling the inrush current for a power factor correcting capacitor bank in an electrical power distribution system. The circuit includes an inrush current limiting device in series with the capacitor bank. The inrush current limiting device, such as a thermistor, varies its resistance in an inverse relationship to its temperature.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to capacitor banks used for controlling the power factor of an electric power distribution system. More particularly, this invention pertains to a device which limits the inrush current when the capacitor bank is connected to the system.

2. Description of the Related Art

Electrical power distribution systems deliver power at a specified voltage and a current related to the needs of the system customer. The power delivered has two components, real power and reactive power. That portion of the power where the voltage is in-phase with the current is considered real. That portion where the voltage is out-of-phase with the current is considered reactive. It is advantageous to both the distribution system provider and the customer to limit the reactive power component. This can be done by bringing the voltage and current into phase.

Capacitor banks are typically used to perform this phase shift because many industrial loads are motors, which are inductive in nature. These industrial loads are not always continuously running and are often switched or varied. Accordingly, the capacitor banks used to correct the power factor are also connected to the circuit on an as-needed basis. These capacitor banks are typically located near the inductive loads, but they may sometimes be located upstream of the loads.

When capacitor banks are first energized, the initial electrical charge within the capacitor bank is usually zero. As the voltage is abruptly applied to the capacitor bank, the impedance of the circuit appears initially to be near zero and a significant inrush current results. This inrush causes variations in the power system voltage and causes variations in the power quality for downstream loads such as solid state variable speed drives and other electronic controls. The current surges and resulting voltage variations have been known in some instances to cause equipment damage and loss of service at some distance from the capacitor bank switching operation.

One previously known method for reducing the inrush current involves using two breakers to connect a capacitor bank to a power distribution bus. A first breaker places the capacitor bank online with a resistor in series with the capacitor bank. A second breaker directly connects the capacitor bank to the bus a short time after the first breaker is closed and serves to bypass the resistor. This results in two switching transients of less magnitude than the transient due to directly connecting the capacitor bank to the bus.

### BRIEF SUMMARY OF THE INVENTION

According to one embodiment of the present invention, a circuit for controlling the inrush current for a capacitor bank is disclosed. The circuit includes an inrush current limiting device in series with the capacitor bank. The inrush current limiting device, such as a thermistor, varies its resistance in an inverse relationship to its temperature. The device limits the inrush current of the capacitor bank to a low value. After a short time, the device's temperature increases from the current flow and its resistance decreases. The capacitor bank is fully in service when the inrush current limiting device reaches a high temperature and a corresponding low resistance.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is single-line diagram of the present invention; and

FIG. 2 is a schematic diagram of the present invention.

### DETAILED DESCRIPTION OF THE INVENTION

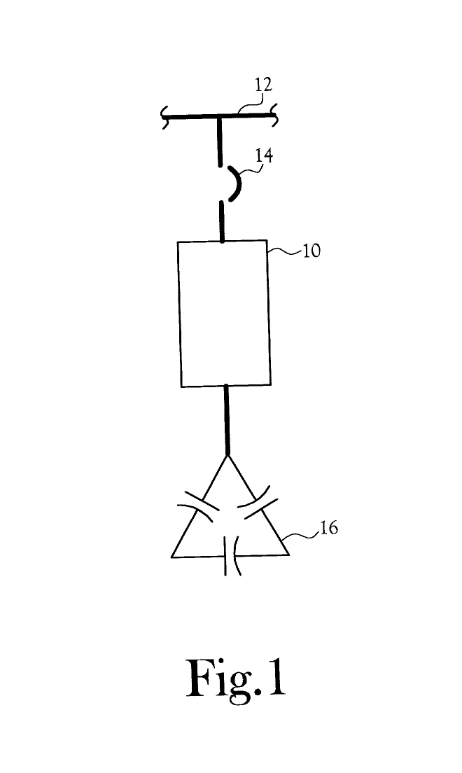

A circuit for controlling the inrush current for a capacitor bank is disclosed. FIG. 1 illustrates a single-line diagram showing a capacitor bank circuit breaker 14 connected to a power distribution bus 12. The circuit breaker 14 connects the power distribution bus 12 to a power factor correction circuit comprising an inrush current limiting device 10 and a capacitor bank 16. Those skilled in the art will recognize that the connection of the power factor correction circuit to the power distribution bus can be at any of various locations in a power distribution system without departing from the spirit and scope of the present invention.

The inrush current limiting device 10 is a device, such as a thermistor, that is typically made of a solid semiconductor material whose electrical resistance decreases with an increase in temperature. That is, at low temperatures, the thermistor has a higher resistance than it does at a higher temperature. Those skilled in the art will recognize that any device that inversely varies its resistance based on temperature may be used without departing from the spirit and scope of the present invention.

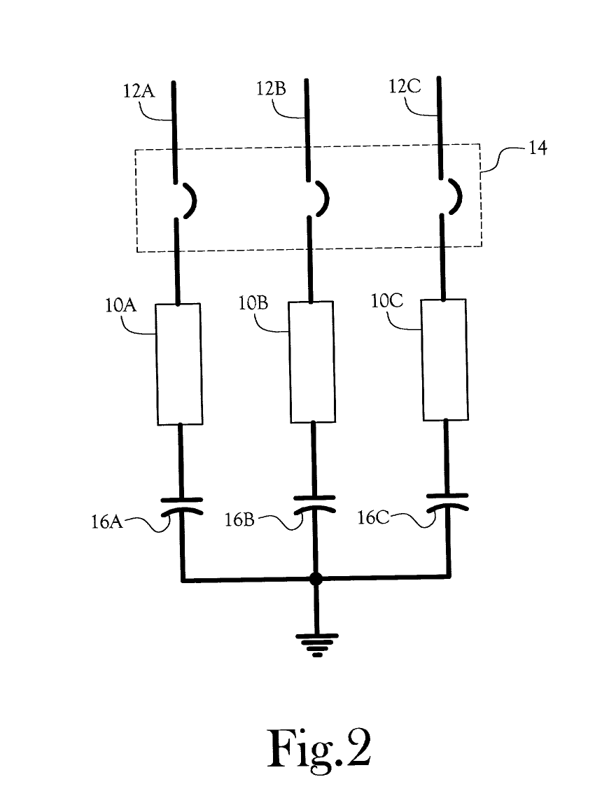

FIG. 2 illustrates a schematic showing a three-phase power circuit. Circuit breaker 14 connects each phase 12A, 12B, and 12C of the power bus 12 to thermistors 10A, 10B, and 10C, respectively, in series with each leg of a capacitor bank 16 including capacitors 16A, 16B, and 16C. The thermistors 10A, 10B, and 10C are generally referred to as the thermistors 10, and the capacitors 16A, 16B, and 16C are generally referred to as the capacitor bank 16. The capacitor bank 16 is illustrated in a grounded Y configuration. Those skilled in the art will recognize that other capacitor bank configurations can be used without departing from the spirit and scope of the present invention.

In operation, if the capacitor bank 16 was disconnected from the system for an extended time, the capacitor bank 16 would be fully discharged and the thermistors 10 would be at ambient temperature. If an inrush current limiting device 10 is not used, connecting a discharged capacitor bank 16 to a power distribution bus 12 results in a large inrush current. However, if the thermistors 10 are in the circuit, connecting a discharged capacitor bank 16 to a bus 12 results in a low inrush current.

The low inrush current achieved by the present invention is due to the high resistance of the thermistors 10 at ambient temperature, and the current through the thermistors 10 and the capacitor bank 16 is inversely related to that resistance. The current flow through the thermistors 10 causes resistive heating of the thermistors 10 and increases their temperature. As the temperature increases, the resistance of the thermistors 10 decreases and the current increases. After a short time, the thermistors 10 attain a high temperature and a corresponding low resistance. The current flow at this low resistance is sufficient to maintain the temperature of the thermistors 10 in a steady state, and the capacitor bank 16 is operating at full current.

From the forgoing description, it will be recognized by those skilled in the art that a circuit for controlling the inrush current for a capacitor bank has been disclosed. Specifically, the inrush current limiting device or thermistor serves to provide a high resistance load when a capacitor bank is initially connected to a power distribution system. The high resistance load becomes a low resistance load after a short time because the device's temperature has increased.

While one embodiment has been shown and described, it will be understood that it is not intended to limit the disclosure, but rather it is intended to cover all modifications and alternate methods falling within the spirit and the scope of the invention as defmed in the appended claims.

Having thus described the aforementioned invention, I claim:

1. A power factor correction circuit for an electrical power distribution system, said power factor correction circuit comprising:
an inrush current limiting device connected in series with a capacitor.

2. The power factor correction circuit according to claim 1, wherein said inrush current limiting device has a resistance that varies from an initial high resistance value to a final low resistance value.

3. The power factor correction circuit according to claim 1, wherein said inrush current limiting device has a resistance that varies inversely in relation to a temperature of said device.

4. The power factor correction circuit according to claim 3, wherein said temperature varies directly in relation to a current flowing through said device.

5. The power factor correction circuit according to claim 4, wherein said temperature increases to a high temperature and said device's resistance decreases to a low resistance value.

6. The power factor correction circuit according to claim 1, wherein said inrush current limiting device comprises at least one thermistor.

7. A power factor correction circuit for an electrical power distribution system, said power factor correction circuit comprising:
a means for varying a resistance in series with a capacitor.
